(19) United States
(12) Patent Application Publication
(10) Pub. No.: US 2025/0086025 A1
(43) Pub. Date: Mar. 13, 2025

(54) METHOD OF OPERATING STORAGE CONTROLLER AND ELECTRONIC SYSTEM

(71) Applicant: Samsung Electronics Co., Ltd., Suwon-si (KR)

(72) Inventor: Hanju Lee, Suwon-si (KR)

(21) Appl. No.: 18/740,563

(22) Filed: Jun. 12, 2024

(30) Foreign Application Priority Data
Sep. 7, 2023 (KR) 10-2023-0118977

(51) Int. Cl. G06F 9/50

(52) U.S. Cl. CPC G06F 9/5055; G06F 9/5016

(57) ABSTRACT

A method of operating an electronic system includes identifying a physical function provided by an input/output device and obtaining resource amount information of the input/output device; determining a resource allocation rule for each of a plurality of allocation unit groups of the input/output device based on the resource amount information; selecting one or more allocation unit groups among the plurality of allocation unit groups based on a required amount of resources and input/output properties of a virtual machine and the resource allocation rule determined for each of the allocation unit groups; generating one or more allocation units for the selected one or more allocation unit groups; and mapping the one or more allocation units to the virtual machine.

### CROSS-REFERENCE TO RELATED APPLICATION(S)

This application claims benefit of priority to Korean Patent Application No. 10-2023-0118977 filed on Sep. 7, 2023, in the Korean Intellectual Property Office, the disclosure of which is incorporated herein by reference in its entirety.

### BACKGROUND

The present disclosure relates to a method of operating a storage controller and a method of operating an electronic system.

A storage device, such as a solid state drive (SSD), may include at least one nonvolatile memory for storing data. A host may store data in the nonvolatile memory using the storage device.

Multiple virtual machines may be executed on a host. A storage device may abstract a physical storage space and may provide a virtual storage device including the abstracted storage space to the virtual machines. The virtual machines may access the virtual storage devices in the same manner of accessing a physical storage device.

### SUMMARY

Example embodiments of the present disclosure provide a method of reducing overhead in allocating resources of a storage device to a plurality of virtual storage devices.

Example embodiments of the present disclosure provide a method of providing stable performance for each of a plurality of virtual storage devices.

According to an example embodiment of the present disclosure, a method of operating an electronic system includes identifying a physical function provided by an input/output device and obtaining resource amount information of the input/output device; determining a resource allocation rule for each of a plurality of allocation unit groups of the input/output device based on the resource amount information; selecting one or more allocation unit groups among the plurality of allocation unit groups based on a required amount of resources and input/output properties of a virtual machine and the resource allocation rule determined for each of the allocation unit groups; generating one or more allocation units for the selected one or more allocation unit groups; and mapping the one or more allocation units to the virtual machine.

According to an example embodiment of the present disclosure, a method of operating an electronic system includes generating a plurality of allocation unit groups with each having different resource allocation rules in response to a resource configuration request; receiving allocation unit generation requests, each allocation unit generation request respectively specifying one of the plurality of allocation unit groups; mapping a plurality of allocation units included in the plurality of allocation unit groups to a plurality of input/output queues provided by the storage controller; and allocating throughput to each of the plurality of allocation units based on the resource allocation rules.

According to an example embodiment of the present disclosure, a method of operating an electronic system includes identifying a plurality of physical functions provided by an input/output device and obtaining resource amount information of the input/output device; allocating a storage capacity and a quality of service (QOS) to each of the plurality of physical functions; providing a resource configuration request to determine a resource allocation rule to each of the plurality of physical functions based on the storage capacity and the QoS allocated to each of the plurality of physical functions; selecting a physical function for which an allocation unit is generated based on an amount of a resource requested by a virtual machine and the resource allocation rule configured for each of the plurality of physical functions; generating one or more allocation units to the selected physical function by providing an allocation unit generation request to the selected physical function; and mapping the one or more allocation units to the virtual machine.

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a diagram illustrating an electronic system according to an example embodiment of the present disclosure;

FIG. 2 is a diagram illustrating a method of operating an electronic system according to an example embodiment of the present disclosure;

FIG. 3 is a diagram illustrating a packet structure of a resource configuration request according to an example embodiment of the present disclosure;

FIG. 4 is a diagram illustrating a table representing resource allocation information for each allocation unit group according to an example embodiment of the present disclosure;

FIG. 5 is a diagram illustrating a mapping table of a virtual machine and an allocation unit according to an example embodiment of the present disclosure;

FIG. 6 is a diagram illustrating a table indicating the amount of resource allocation for each allocation unit group according to an example embodiment of the present disclosure;

FIG. 7 is a diagram illustrating a method of scheduling input/output requests of an electronic system according to an example embodiment of the present disclosure;

FIG. 8 is a diagram illustrating a request scheduling method of a storage device according to an example embodiment of the present disclosure;

FIG. 9 is a flowchart illustrating a request scheduling method of a storage device according to an example embodiment of the present disclosure;

FIGS. 10A to 10C are diagrams illustrating an electronic system according to an example embodiment of the present disclosure;

FIG. 11 is a diagram illustrating an electronic system according to an example embodiment of the present disclosure; and

FIG. 12 is a diagram illustrating a server system to which an electronic system is applied according to an example embodiment of the present disclosure.

### DETAILED DESCRIPTION

Hereinafter, embodiments of the present disclosure will be described as follows with reference to the accompanying drawings. Although the figures described herein may be referred to using language such as “one embodiment,” or “certain embodiments,” these figures, and their corresponding descriptions are not intended to be mutually exclusive from other figures or descriptions, unless the context so indicates. Therefore, certain aspects from certain figures may be the same as certain features in other figures, and/or certain figures may be different representations or different portions of a particular exemplary embodiment.

As used herein, the singular forms “a”, “an” and “the” are intended to include the plural forms as well, unless the context clearly indicates otherwise. As used herein, the term “and/or” includes any and all combinations of one or more of the associated listed items and may be abbreviated as “/”.

Ordinal numbers such as “first,” “second,” “third,” etc. may be used simply as labels of certain elements, steps, etc., to distinguish such elements, steps, etc. from one another. Terms that are not described using “first,” “second,” etc., in the specification, may still be referred to as “first” or “second” in a claim. In addition, a term that is referenced with a particular ordinal number (e.g., “first” in a particular claim) may be described elsewhere with a different ordinal number (e.g., “second” in the specification or another claim).

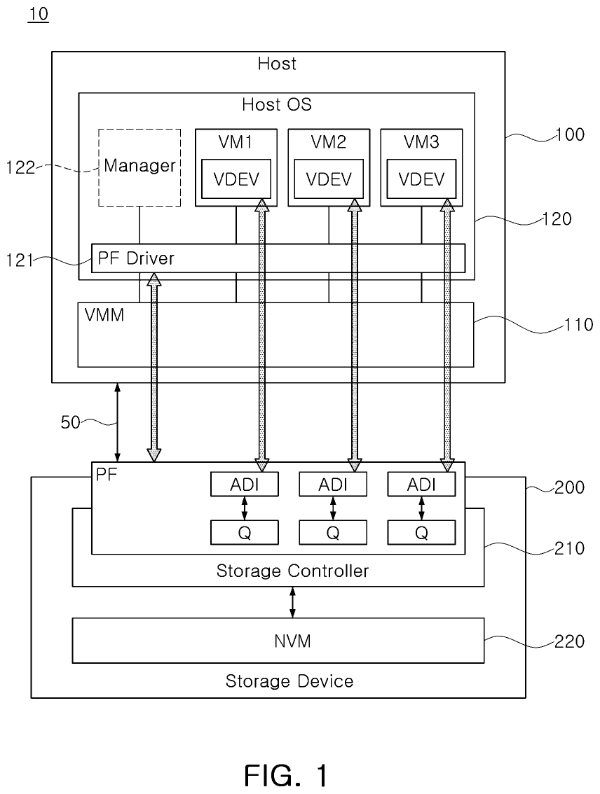

FIG. 1 is a diagram illustrating an electronic system according to an example embodiment.

Referring to FIG. 1, an electronic system 10 may include a host 100, a storage device 200, and a bus 50 connecting the host 100 to the storage device 200.

The host 100 may be configured as a computing device such as a desktop computer, a laptop computer, a network server, or a mobile device. The host 100 may include an application processor, a microprocessor, a central processing unit (CPU), a processor core, a multi-core processor, a multiprocessor, an application-specific integrated circuit (ASIC) and a field programmable gate array (FPGA).

The storage device 200 may store data in response to a request from the host 100. For example, the storage device 200 may include at least one of a solid state drive (SSD), an embedded memory, or a removable external memory.

The storage device 200 may include a storage controller 210 and a nonvolatile memory device 220. The nonvolatile memory device 220 may be configured as a storage medium storing data received from the host 100 and may include, for example, a flash memory. The storage controller 210 may control the nonvolatile memory device 220.

When the storage device 200 is configured as an SSD, the storage device 200 may be configured as a device conforming to the non-volatile memory express (NVMe) standard. When the storage device 200 is configured as a device conforming to the NVMe standard, the bus 50 may be configured as a peripheral component interconnect express (PCIe) bus.

The host 100 may provide a plurality of isolated execution environments referred to as virtual machines VM. Virtualization may be a mechanism which integrates a workload of a plurality of virtual machines VM on a single physical machine while maintaining the isolated workloads of each of the plurality of virtual machines VM, and may be widely used in a cloud server, or the like. The host 100 may provide the virtual machine VM and may also provide other types of isolated execution environments such as a container.

Referring to FIG. 1, the host 100 may generate a plurality of virtual machines VM1, VM2, and VM3 executed by a host operating system by executing a virtual machine manager VMM (110), or software known as hypervisor. The virtual machine manager 110 may be configured as a component of the host operating system 120 and may be provided by an application executing on the host operating system 120.

The virtual machine manager 110 may abstract physical resources including a processor, a memory, and an input/output device, and may provide abstracted physical resources to the virtual machines VM1, VM2, and VM3 as virtual devices including a virtual processor, a virtual memory, and a virtual input/output device. Each of the virtual machines VM1, VM2, and VM3 may execute a guest operating system using a virtual device. On a guest operating system, one or more applications may be executed.

The host 100 may provide a function which may allow the virtual machines VM1, VM2, and VM3 to directly access an input/output device, such as the storage device 200, instead of accessing the input/output device through software that emulates the input/output device.

For example, a single root input/output virtualization (SR-IOV) architecture may support providing a plurality of virtual input/out devices for a physical input/output device such that the virtual machines VM1, VM2, and VM3 may share the physical input/output device. For example, an endpoint device supporting SR-IOV may support one or more physical functions PF corresponding to an input/output port, and each physical function may support a plurality of virtual functions VF.

A physical function PF is a PCI (e.g., PCIe) function that may be discovered, managed, and manipulated in the same manner as any other PCI device. A physical function may be a PCI function that supports SR-IOV capabilities as defined by the SR-IOV specification. Each of the one or more physical functions PF may appear as a different physical device on the host 100. The host 100 may independently and individually access the one or more physical functions PF.

A virtual function VF is a virtualized instance of a physical function PF that shares physical resources with the physical function PF. In a single root input/output virtualization (SR-IOV) architecture, a physical function PF may have multiple virtual functions which may each be allocated to a virtual machine to allow for sharing of the physical PF. Virtual functions may be dedicated (mapped) to virtual machines VMs to allow each VM to use the virtual function as though it is a hardware device. For example, a VM may issue an I/O command to a virtual function VF assigned to the VM, and the associated physical function PF, referencing a virtual function map, may perform the I/O command on behalf of the virtual function VF and return an I/O response to the corresponding (assigned) virtual function VF to complete the I/O command.

The physical function PF may be managed by the PF driver 121 in the host operating system, and the plurality of virtual functions VF may be allocated to the virtual machines.

When the electronic system 10 is configured as a large-scale server such as a cloud server, the host 100 may provide thousands or more virtual machines. The storage device 200 may support a scalable-IOV architecture (S-IOV) in order to provide virtualized resources to a plurality of virtual machines on a granular basis.

The S-IOV architecture may configure a virtual device more flexibly compared to the SR-IOV. Also, among tasks for the virtual devices, tasks considered important in performance may be mapped directly to the input/output device, and tasks considered relatively unimportant in performance may be emulated through software in the host operating system 120.

To virtualize resources of the storage device 200 in greater granularity, an allocation unit called an allocatable device interface (ADI) allocation unit, which may hereafter be referred to as an allocation unit ADI, may be defined in the S-IOV architecture. The allocation unit ADI may be an isolated allocation unit and may refer to a set of resources which may be allocated, configured, and organized. For example, an allocation unit ADI for the storage controller 210 may be a set of input/output queues Q that are each associated with a namespace of the storage device. That is, each allocation unit ADI may be mapped to one or more input/output queues Q.

The allocation unit ADI may be managed in the physical function PF and may be similar to the virtual function VF of the SR-IOV architecture in that the allocation unit ADI may be directly accessed by a virtual machine VM.

However, in contrast to the SR-IOV architecture in in which the virtual functions VF have request identifiers (RID) different from those of the physical function PF, the allocation unit ADI may share the RID of the physical function PF. To enable the requests of the allocation unit ADI sharing a RID to be distinguished, a process address space identifier (PASID) added to a transaction layer packet may be allocated to each allocation unit ADI. Since the PASID may support a 20-bit identifier, the PASID may provide more identifiers as compared to the RID which may support a 16-bit identifier. Accordingly, the S-IOV architecture may support a larger number of allocation units ADI than the number of virtual functions supportable in the SR-IOV architecture.

The storage device 200 may be virtualized with a plurality of virtual devices VDEV. The plurality of virtual devices VDEV may be exposed to software on the virtual machines VM1, VM2, and VM3. For example, similarly to the virtual functions VF supported in the SR-IOV architecture, the plurality of virtual devices VDEV may each be mapped to a corresponding virtual machine such as virtual machines VM1, VM2, and VM3.

The plurality of virtual devices VDEV may be configured using the plurality of allocation units ADI. For example, the host operating system 120 may map one or more of the plurality of allocation units ADI generated on the physical function PF to a virtual device VDEV. In the description below, the mapping of an allocation unit ADI to a virtual device VDEV corresponding to a virtual machine VM may be briefly referred to as mapping the allocation unit ADI to the virtual machine VM. In the drawings, a manager 122 may map the allocation unit ADI to the virtual machine VM in the host operating system.

The manager 122 may be a software component executed in the host operating system 120, and according to an example embodiment, the manager 122 may be integrated into the virtual machine manager 110. However, in an example embodiment, the manager 122 is not limited to being integrated into the virtual machine manager 110, and the manager 122 may be implemented as a virtual machine such as a secure core.

The physical function PF may dynamically generate, manage, and delete an allocation unit ADI. When the host 100 provides more than thousands of virtual machines VM, the physical function PF may generate and manage more than thousands of allocation units ADI to map the allocation units ADI to the plurality of virtual machines VM. The physical function PF may manage each allocation unit ADI having various amounts of resource allocation. For example, the physical function PF may manage the plurality of allocation units ADI which may have different storage capacities or different quality of service (QOS).

The QOS may refer to the ability of the storage controller 210 to prioritize data flow from among different allocation units ADI and to ensure stable and consistent performance in data input/output operation of each device resource in different allocation units ADI. For example, the QoS indicators may include input/output operations per second (IOPS), response time, throughput, or the like.

In order for the host operating system 120 to allocate resources to the plurality of allocation units ADI on the basis of the amount of resources required for each of the plurality of virtual machines VM, an efficient method of allocating resources to the plurality of allocation units ADI may be necessary. Also, to provide the QoS required for the virtual machines VM, it may be desirable to effectively schedule requests for the plurality of allocation units ADI.

According to an example embodiment, the host 100 may generate a plurality of allocation unit groups in which different pieces of resource allocation information are defined. The resource allocation information may include storage capacity, QoS, or the like. To allocate resources to the allocation unit ADI, the host 100 may specify allocation unit groups in which the allocation units ADI may be included, respectively. In the allocation units ADI, resources may be allocated on the basis of resource allocation information defined in the allocation unit group. The host 100 may configure a virtual device VDEV using one or more allocation units ADI.

According to an example embodiment, the host 100 may allocate resources to the allocation units ADI by selecting a resource allocation type on the basis of predetermined resource allocation information, instead of specifying each amount of resource allocation of the allocation units ADI. Also, since the plurality of allocation units ADI may be typed according to the resource allocation information, the virtual device VDEV may be easily configured by combining the allocation units ADI typed according to the amount of resource required for the virtual machine VM. Accordingly, overhead for allocating resources to the allocation unit ADI and configuring the virtual device VDEV may be reduced.

The storage device 200 may efficiently schedule the requests from the host 100 for the plurality of allocation units ADI by scheduling the requests on the basis of allocation unit groups to which the plurality of allocation units ADI belongs, and may provide stable performance for the plurality of allocation units ADI to the virtual machines.

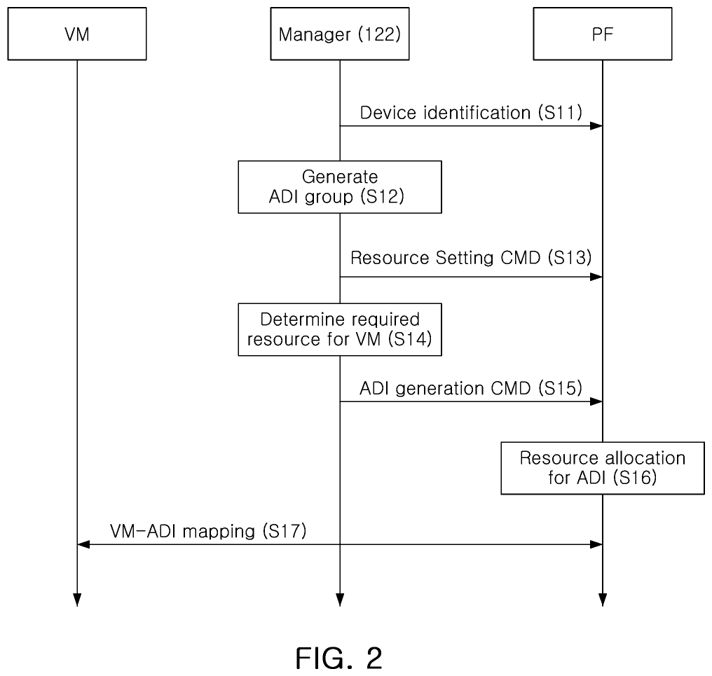

In the description below, operations of an electronic system according to an example embodiment will be described in greater detail with reference to FIGS. 2 to 9.

FIG. 2 is a diagram illustrating a method of operating an electronic system according to an example embodiment. The method will be described with reference to the components of FIG. 1, although embodiments of the method are not limited to the electronic system of FIG. 1. For example, although the description of the method may identify the host 100, this is for convenience of description and the method may be performed on a host other than the host 100 of FIG. 1.

In FIG. 2, a transaction between the virtual machine VM, the manager 122, and the physical function PF included in the electronic system is illustrated. The virtual machine VM may be one of the virtual machines VM1, VM2, and VM3 described with reference to FIG. 1, and the manager 122 and the physical function PF may correspond to the manager 122 and the physical function PF described with reference to FIG. 1.

In operation S11, the manager 122 may identify the physical function PF provided by the storage device 200 by enumerating the input/output devices connected to the host 100.

The manager 122 may further obtain resource amount information of the physical function PF. The resource amount information may include storage capacity of the storage device 200, maximum number of allocation units ADI supported by the physical function PF, maximum number of the input/output queues, maximum number of namespaces, a bandwidth of the storage device 200, and maximum quality of service (QOS), or the like.

Operation S11 may be triggered upon initialization of the storage device 200 providing the physical function PF.

In operation S12, the manager 122 may generate the plurality of allocation unit groups (ADI groups) and may determine a resource allocation rule for each of the plurality of allocation unit groups. As a first example, the manager 122 may determine the amount of resources to be allocated to each allocation unit ADI to be generated in each of the plurality of allocation unit groups. As a second example, the manager 122 may determine the amount of resources to be allocated for each allocation unit group and a resource allocation policy for each allocation unit group, and may allow the physical function PF to determine the amount of resources to be allocated to each allocation unit ADI according to the configured resource allocation policy.

In operation S13, the manager 122 may provide a resource configuration request to the physical function PF to determine a resource allocation rule for the plurality of allocation unit groups. The resource configuration request may be a request to notify the physical function PF of the amount of resources to be allocated for the plurality of allocation unit groups defined in the manager 122, and the resources held (reserved) by the physical function PF may actually be allocated to the allocation units ADI through an allocation unit generate command in which the physical function PF may perform the actual allocation in response to an allocation unit generation command.

In example embodiments, a resource configuration request may be provided in the format of a set feature command. The set feature command may refer to a command used to change the configuration of the storage device 200, and the set feature command may be one type of admin-command.

In other embodiments, the resource configuration request is not limited to being provided in the format of a set feature command. For example, a resource configuration request may be provided through commands in various formats defined in standards such as NVMe, and may be provided through a sideband signal transmitted through a dedicated wire or a pin allocated separately from the command wire or pin.

In operation S14, the manager 122 may determine the amount of resources required for the virtual machine VM. The electronic system 10 may provide resources allocated according to a policy to a user who uses the virtual machine VM. For example, the electronic system 10 may provide cloud storage having differentiated storage capacity and QoS depending on a usage fee collected from users. Accordingly, the storage capacity and QoS required for each of the virtual machines VM1, VM2, and VM3 may be individually determined.

In example embodiments, the manager 122 may further determine input/output properties required for the virtual machine VM. For example, the input/output properties may include write-intensive properties, read-intensive properties, and mixed performance properties.

In operation S15, the manager 122 may request the physical function PF to generate one or more allocation units ADI on the basis of the amount of resources and input/output properties determined in operation S14.

For example, the manager 122 may select one or more allocation unit groups among the plurality of allocation unit groups on the basis of the amount of resources and input/output properties required for the virtual machine VM and the resource allocation rule for each allocation unit group, and may determine the number of allocation units ADI to be generated for selected one or more allocation unit groups. Also, the manager 122 may provide an allocation unit generation request for specifying an identifier of the allocation unit ADI and the selected one or more allocation unit groups as the physical function PF.

In operation S16, the physical function PF may generate one or more allocation units ADI in response to an allocation unit generation request, and may allocate resource to the generated allocation unit ADI on the basis of the resource allocation rule configured in the allocation unit group to which the generated allocation unit ADI belongs.

For example, the physical function PF may determine the storage capacity of a logical storage space, for example, a namespace, provided by the storage device 200 in response to the resource configuration request, and may allocate storage capacity to the allocation unit ADI by mapping the logical storage space to the allocation unit ADI.

The physical function PF may allocate QoS to the allocation unit ADI in response to the resource configuration request. Allocating QoS to the allocation unit ADI may include allocating a resource of a size sufficient to guarantee the QoS to the allocation unit ADI, and scheduling input/output requests corresponding to the allocation unit ADI on the basis of the QoS, thereby ensuring the QoS.

In operation S17, the manager 122 may map the virtual machine VM and one or more generated allocation units ADI.

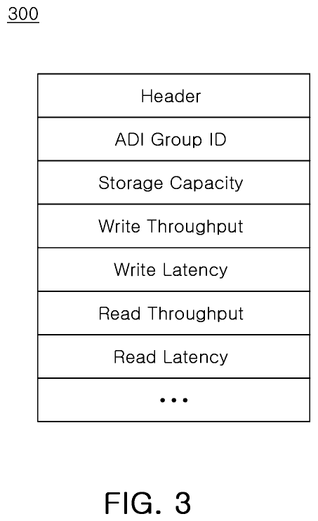

In the description below, a method of managing the amount of resource allocation of the plurality of allocation units ADI in host 100 will be described in greater detail with reference to FIGS. 3 to 6.

FIG. 3 is a diagram illustrating a packet structure of a resource configuration request according to an example embodiment.

Referring to FIG. 3, a packet 300 of the resource allocation command provided by the manager to the storage device 200 may include a header, an identifier for each allocation unit group, and a resource allocation rule for the allocation unit group. The resource allocation rule of the allocation unit group may include storage capacity, write throughput, write latency, read throughput, and read latency of the allocation unit ADI to be generated in the allocation unit group. Write throughput, write latency, read throughput, and read latency may be included in the QoS.

FIG. 3 illustrates an example of a packet including resource allocation information in which the resource allocation information individually specifies write throughput and read throughput for the allocation group, but in other embodiments resource allocation information may specify a single throughput applied to a write request and a read request. Similarly, in some embodiments, the resource allocation information may specify write latency and read latency individually, or may also specify a single latency applied to a write request and a read request.

The amount of resources to allocate, such as an identifier range, storage capacity, write throughput, write latency, read throughput, and read latency, may be commonly applied to each allocation unit ADI included in the allocation unit group.

In example embodiments, a resource allocation command may include resource allocation information for each of the plurality of allocation unit groups. That is, the manager may request to determine resource allocation information for each of the plurality of allocation unit groups by providing a resource allocation command to the physical function PF.

According to an example embodiment, instead of individually determining the amount of resources to allocate to each allocation unit ADI included in the allocation unit group, the manager may determine resource allocation information for each allocation unit group and may map the allocation units ADI to the allocation unit group when the allocation units ADI are generated, thereby determining the amount of resources to allocate to the allocation units ADI. The overhead of the host 100 and the bus 50 when allocating resources to the plurality of allocation units ADI may be reduced.

When resources are allocated uniformly in the allocation units ADI included in the allocation unit group, resources allocated to a virtual machine VM may be unitized. For example, depending on the required amount of resources and input/output properties of the virtual machine VM, it may be easily determined how many allocation units ADI included in which allocation unit group may be allocated to the virtual machine VM. Accordingly, the manager 122 may flexibly allocate resources to the virtual machine VM, and the overhead for determining the allocation units ADI to be mapped to the virtual machine VM may be reduced.

The manager 122 may store resource allocation information for each allocation unit group in order to determine the amount of resources to allocate and input/output properties of newly generated allocation units ADI.

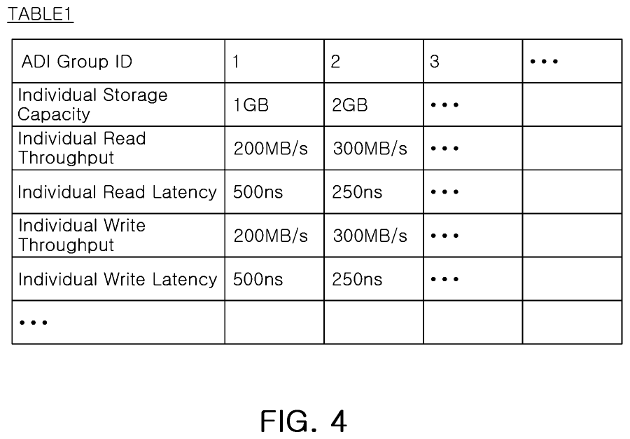

FIG. 4 is a diagram illustrating a table representing resource allocation information for each allocation unit group of a plurality of groups according to an example embodiment.

In the example in FIG. 4, individual allocation units ADI included in an allocation unit group may have the same storage capacity and performance as one another, and the first table TABLE1 may include storage capacity and performance of each individual allocation unit ADI. Referring to FIG. 4, the first table TABLE1 may include an allocation unit group identifier (ADIG ID), individual storage capacity, individual read throughput, individual read latency, individual write throughput, and individual write latency.

The first table TABLE1 may be stored in the memory of the host 100 and may be referenced by the manager 122. For example, the manager 122 may refer to the first table TABLE1 to generate one or more allocation units ADI based on the amount of resources and input/output properties required for a virtual machine VM. Specifically, the manager 122 may type allocation units AGI by defining the allocation unit groups. Also, on the basis of the amount of resources and input/output properties required for the virtual machine VM, by determining the allocation unit group to which the newly generated allocation unit ADI belongs and determining the number of newly generated allocation units ADI, the resources of the storage device 200 may be easily shared with the virtual machine VM.

For example, the amount of resources, such as storage capacity and QoS, required for each virtual machine VM may be different, and each virtual machine VM may have various input/output properties such as read-intensive properties, write-intensive properties, and mixed properties, or the like.

Different storage capacities and QoS may be defined for each allocation unit groups, and the storage capacity and QoS may define input/output properties as well as the amount of resources provided by the allocation unit ADI. For example, when the write throughput is higher than the read throughput of the allocation unit ADI, write-intensive properties may be included, when the read throughput is higher than the write throughput, read-intensive properties may be included, and when the write throughput and read throughput are the same, mixed properties may be included. The manager 122 may select at least one of the allocation unit groups having various input/output properties on the basis of the input/output properties required for the virtual machine VM, and may determine the number of allocation units ADI to be newly generated for the selected allocation unit groups on the basis of the amount of resources required for the virtual machine VM.

According to an example embodiment, since the plurality of allocation units ADI may be typed into several allocation unit groups, the manager 122 may easily allocate allocation units ADI to provide the required amount of resources and input/output properties to the virtual machine VMs. Accordingly, the overhead required for resource allocation may be reduced.

The host 100 may further store a mapping table between virtual machines and allocation units ADI.

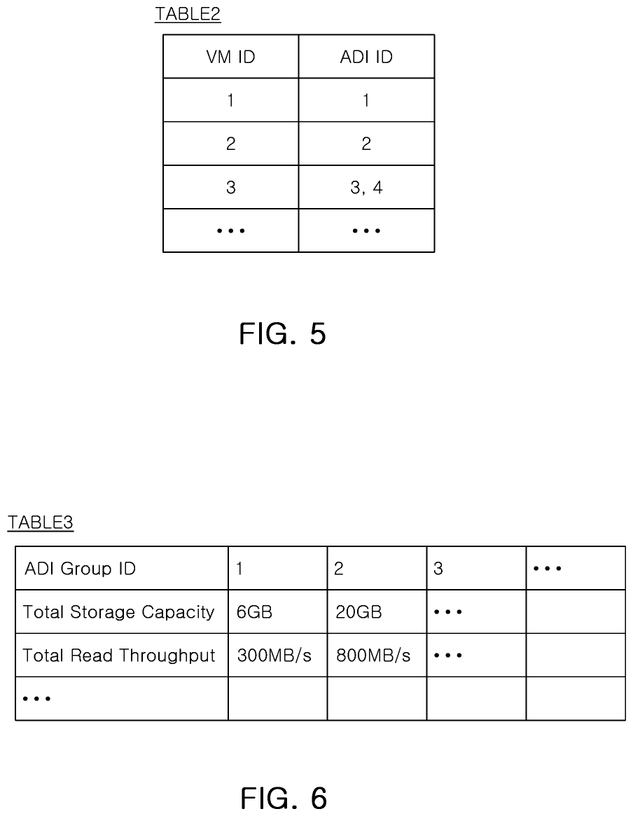

FIG. 5 is a diagram illustrating a mapping table of virtual machines and allocation units according to an example embodiment.

Referring to FIG. 5, a second table TABLE2 may include an identifier VM ID of each virtual machines VM and an allocation unit identifier ADI ID of each allocation unit ADI mapped to a respective virtual machine VM. Referring to FIG. 5, each virtual machine VM may be mapped to one or more allocation units ADI.

The second table TABLE2 may be stored in the memory of the host 100 and may be referenced by the manager 122. For example, when the manager 122 newly maps an allocation unit ADI to the virtual machine VM, the manager 122 may identify an allocation unit ADI not mapped to another virtual machine VM by referring to the second table TABLE2.

In the example of FIG. 4, the manager 122 defines the amount of resource allocation of the individual allocation units ADI for each allocation unit group, but embodiments are not limited thereto. For example, the manager 122 may determine the total amount of resource allocation for each allocation unit group, and the storage device 200 may determine the amount of resource allocation of each allocation unit ADI on the basis of the total amount of resource allocation for each allocation unit group and may allocate resources to the individual allocation units ADI.

FIG. 6 is a diagram illustrating a mapping table indicating the total amount of resource allocation for each allocation unit group according to an example embodiment.

Referring to FIG. 6, a third table TABLE3 may include the total amount of resource allocation of each allocation unit AGI group, along with the allocation unit group identifier (ADIG ID). For example, the third table TABLE3 may include the total storage capacity and the total throughput of an allocation unit group. In example embodiments, the third table TABLE3 may further define the input/output properties of the allocation unit group by further defining a ratio between the read throughput and the write throughput and/or a ratio between the storage capacity and the throughput of each allocation unit ADI.

According to an example embodiment, the manager 122 may provide a resource configuration request including the total storage capacity and the total throughput of the allocation unit group to the physical function PF, and may optionally provide a resource configuration request including the ratio of the read throughput and the write throughput to the physical function PF. The physical function PF may allocate resources to the individual allocation units ADI included in the allocation unit group on the basis of the total storage capacity, the total throughput, and one or more policies of the allocation unit group.

As a first example of a policy, the physical function PF may determine and allocate the same storage capacity and throughput to each allocation unit ADI in the range of the total storage capacity and the total throughput of the allocation unit group. In an example in which the total storage capacity of a first allocation unit group (ADI Group ID=1) is 6 GB and the total throughput is 300 MB/s, the same storage capacity of 1 GB and the throughput of 50 MB/s may be allocated to the allocation units ADI included in the first allocation unit group (ADI Group ID=1). According to the total storage capacity and the total throughput defined in the allocation unit group and the storage capacity and throughput defined in the individual allocation units ADI of the allocation unit group, the maximum number of individual allocation units ADI included in the allocation unit group may be determined. When the maximum number of individual allocation units ADI would be exceeded, such as from receiving a new generation request to generate a new individual allocation unit ADI, the physical function PF may deny the generation request.

As a second example of the policy, the physical function PF may allocate storage capacity and throughput to each allocation unit ADI such that the ratio between the storage capacity and the throughput of each allocation unit ADI may be constant in the range of total storage capacity and the total throughput of the allocation unit group.

In the second example of the policy, the storage capacity of an allocation unit ADI may be individually defined. That is, an allocation unit generation request May include a storage capacity to be allocated to the allocation unit ADI, along with an identifier of the allocation unit ADI and an identifier of the allocation unit group. For example, in an example in which the total storage capacity of a second allocation unit group (ADI Group ID=2) is 20 GB and the total throughput is 800 MB/s, when the physical function PF receives a resource configuration request from the manager 122 to generate a first allocation unit ADI belonging to the second allocation unit group and having a storage capacity of 1 GB, the physical function PF may allocate 1 GB of storage capacity and 40 MB/s of throughput to the first allocation unit ADI (e.g., 20/800=1/40). Also, when the physical function PF receives a resource configuration request from the manager 122 to generate a second allocation unit ADI having storage capacity of 2 GB, the physical function PF may allocate a storage capacity of 2 GB and a throughput of 80 MB/s to the second allocation unit ADI (e.g., 20/800=2/80).

When the ratio between the read throughput and the write throughput is defined for the allocation unit group, the physical function PF may distribute the throughput allocated to the allocation unit ADI to the read throughput and the write throughput of the allocation unit ADI.

Providing the storage capacity allocated to the allocation units ADI by the storage device 200 may be obtained by determining the size of the namespace mapped to the allocation units ADI. Also, providing the throughput allocated to the allocation units ADI by the storage device 200 may be obtained by allocating one or more input/output queues Q of the storage controller 210 to each allocation unit ADI on the basis of the throughput of the allocation units ADI and scheduling the input/output requests for the allocation units ADI.

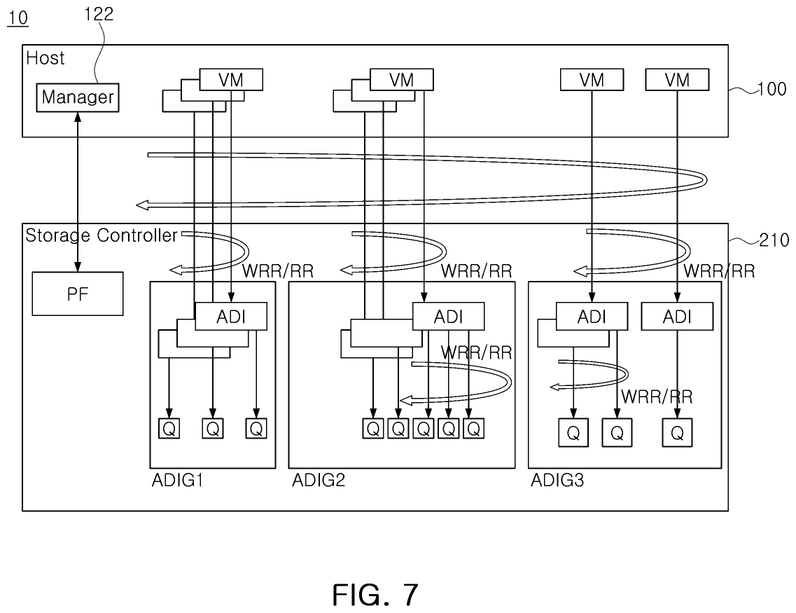

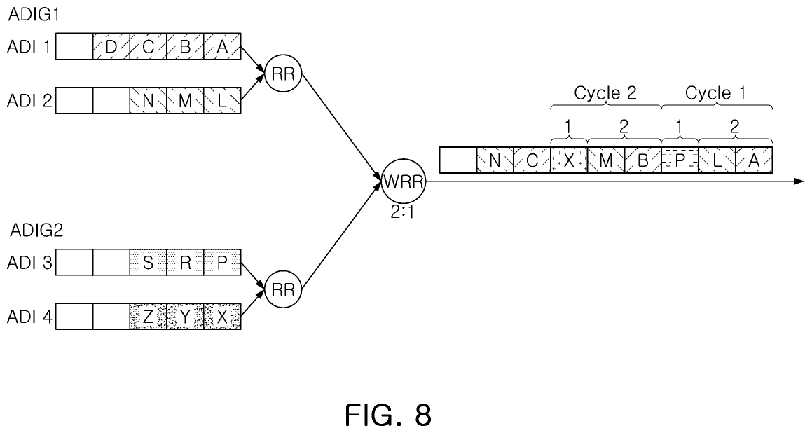

In the description below, a method of scheduling input/output requests for individual allocation units ADI on the basis of the throughput of the individual allocation units ADI will be described in greater detail with reference to FIGS. 7 and 8.

FIG. 7 is a diagram illustrating a method of scheduling input/output requests of an electronic system according to an example embodiment.

FIG. 7 illustrates a portion of components of an electronic system such as the electronic system 10 described with reference to FIG. 1. Although the method is described with reference to the electronic system 10 of FIG. 1, embodiments are not so limited. The host 100 may include a plurality of virtual machines VM and a manager 122. The storage controller 210 may provide a physical function PF, and the physical function PF may provide a plurality of allocation units ADI. The manager 122 may request the physical function PF to generate the allocation units ADI and map the allocation units ADI to the virtual machines VM.

As described with reference to FIGS. 3 to 6, the physical function PF may provide a plurality of allocation unit groups ADIG1, ADIG2, and ADIG3 having different amounts of resource allocation and different input/output properties in response to a resource configuration request from the manager 122. Also, the physical function PF may generate allocation units ADI included in one of the plurality of allocation unit groups ADIG1, ADIG2, and ADIG3 in response to an allocation unit generation request from the manager 122.

One or more input/output queues Q may be allocated to each of the allocation units ADI. Also, one or more allocation units ADI may be allocated to each of the plurality of virtual machines VM.

When the physical function PF provides the plurality of allocation units ADI, a plurality of input/output requests may be queued in the plurality of input/output queues Q allocated to the plurality of allocation units ADI. When the plurality of input/output requests are not effectively scheduled in the storage controller 210, input/output requests may not be processed in a timely manner, and it may be difficult to guarantee a QoS allocated to the allocation unit ADI.

According to an example embodiment, the storage controller 210 may schedule input/output requests queued in the plurality of input/output queues Q using a multiple round robin method. Specifically, the storage controller 210 may provide a request processing opportunity to the plurality of allocation unit groups ADIG1, ADIG2, and ADIG3 by a round robin method, and the request processing opportunity provided to one allocation unit group may be provided to the plurality of allocation units ADI included in the one allocation unit group by a round robin method.

The request processing opportunity of one allocation unit ADI may be provided to the input/output queue Q mapped to the one allocation unit ADI, and the input/output request queued to the input/output queue Q having the request processing opportunity may be processed. When one allocation unit ADI has a plurality of input/output queues Q, the request processing opportunity provided to one allocation unit ADI may be provided to the plurality of input/output queues Q by the round robin method. Here, the round robin method may include a simple round robin method RR and a weighted round robin method WRR.

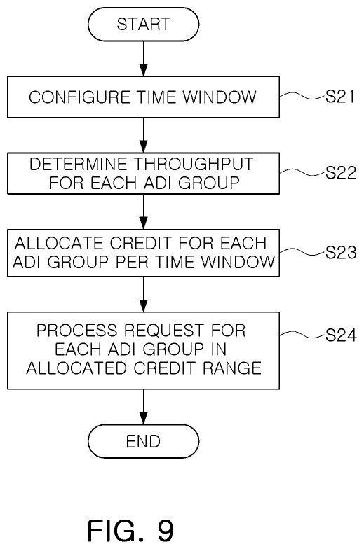

In the description below, the request scheduling method of the storage controller according to the multiple round robin method is described in greater detail with reference to FIGS. 8 to 9.

FIG. 8 is a diagram illustrating a request scheduling method of a storage device according to an example embodiment.

FIG. 8 illustrates the request scheduling method according to a multiple round robin method with reference to the example in which the physical function PF has first and second allocation unit groups ADIG1, ADIG2, first allocation unit group ADIG1 has first and second allocation units ADI1, ADIG2, the second allocation unit group ADIG2 has third and fourth allocation units ADI3 and ADI4, and the first to fourth allocation units ADI1, ADI2, ADI3, and ADI4 each have an input/output queue Q.

A plurality of requests A, B, C, D, L, M, N, P, R, S, X, Y, and Z may be queued to the input/output queues Q of the first to fourth allocation units ADI1, ADI2, ADI3, and ADI4. The storage controller 210 may perform request scheduling to determine an order of processing the plurality of requests according to the multiple round robin method.

In the example in FIG. 8, a request processing opportunity may be provided to one of the first allocation unit group ADIG1 and the second allocation unit group ADIG2 using the weighted round robin WRR method. The weights of the first and second allocation unit group ADIG1 and ADIG2 may be “2” and “1”, respectively. During a cycle in which at least one request processing opportunity is provided to both the first and second allocation unit group ADIG1 and ADIG2, the first allocation unit group ADIG1 may have two request processing opportunities, and the second allocation unit group ADIG2 may have one request processing opportunity.

In a first example, the first and second allocation unit groups ADIG1 and ADIG2 may have weights determined according to a ratio of QoS allocated to the first allocation unit group ADIG1 and the second allocation unit group ADIG2. In a second example, the weights may be determined according to the ratio of throughputs between the first allocation unit group ADIG1 and the second allocation unit group ADIG2. In a third example, to determine the weights, latency may be further considered in addition to the throughput ratio. In some examples, one or more of the ratio of the QoS, the ratio of the throughputs, or the latency may be used to determine the weights.

A request processing opportunity may be provided to one of the first and second allocation units ADI1 and ADI2 using the simple round robin RR method, and a request processing opportunity may be provided between the third and fourth allocation units ADI3 and ADI4 using the simple round robin RR method. However, when the throughput is different between the first and second allocation units ADI1 and ADI2, and the third and fourth allocation units ADI3 and ADI4, the request processing opportunity may be provided using the weighted round robin WRR method.

In a first cycle Cycle1 according to the multiple round robin method, the first allocation unit group ADIG1 may have two request processing opportunities, and the second allocation unit group ADIG2 may have one request processing opportunity. The two request processing opportunities of the first allocation unit group ADIG1 may be provided in turns to the first and second allocation units ADI1 and ADI2. Also, one request processing opportunity of the second allocation unit group ADIG2 may be provided to the third allocation unit ADI3. For example, in the first cycle Cycle1, requests may be processed in the order of A-L-P.

In a second cycle Cycle2, the two request processing opportunities of the first allocation unit group ADIG1 may be provided to the first and second allocation units ADI1 and ADI2 in turns. Also, one request processing opportunity of the second allocation unit group ADIG2 may be provided preferentially to the fourth allocation unit ADI4. For example, in the second cycle Cycle2, requests may be processed in the order of B-M-X.

To process requests queued in the plurality of input/output queues Q without delay according to the multiple round robin method, the order of the request processing opportunities between the plurality of input/output queues Q and also the size of data input/output to the request processing opportunities may also be determined. For example, the size of data which may be input/output may be controlled by a credit-based method.

FIG. 9 is a flowchart illustrating a request scheduling method of a storage device according to an example embodiment.

In operation S21, the storage controller 210 may determine the size of a time window. The time window may be a credit-based method and may refer to the period in which a credit is newly allocated when requests queued in input/output queues Q are scheduled.

In operation S22, the storage controller 210 may determine throughput for each allocation unit group. For example, the storage controller 210 may determine the throughput for each allocation unit group on the basis of throughput of the currently generated allocation units ADI for each allocation unit group.

In operation S23, the storage controller 210 may allocate a credit for each allocation unit group per time window.

A credit may refer to an opportunity to process input/output requests for a determined amount of data. The storage controller 210 may allocate a plurality of credits to each allocation unit group on the basis of the size of the throughput and a time window of the allocation unit group. For example, when the throughput of the allocation unit group is 300 MB/s and the time window size is 10 ms, a number of credits corresponding to 3 MB of data may be allocated to each allocation unit group.

In operation S24, the storage controller 210 may process requests for each allocation unit group in the allocated credit range.

As described previously, the storage controller 210 may schedule a plurality of requests using a multiple round robin method. When processing a request, the storage controller 210 may deduct a credit of the allocation unit group associated with the request on the basis of the size of input/output data associated with the request. Also, even when a request processing opportunity is provided to an input/output queue, the storage controller 210 may skip request processing for the input/output queue when the credit of the allocation unit group associated with the input/output queue is exhausted.

According to an example embodiment, the storage controller 210 may schedule requests queued in the plurality of input/output queues Q using a multiple round robin method and may control data throughput using a credit-based control method, such that the QoS defined in each of the allocation unit groups ADIG1, ADIG2, and ADIG3 and the QoS allocated to the individual allocation unit ADI may be guaranteed.

As described with reference to FIGS. 7 to 9, the storage controller 210 may queue input/output requests in the input/output queues Q without distinguishing between a read request and a write request, and the read request and the write request may be scheduled without being distinguished from each other. However, example embodiments thereof are not limited thereto.

As described above, read throughput and write throughput may be configured in the allocation unit ADI. According to an example embodiment, to ensure read throughput and write throughput of each allocation unit ADI, the input/output queue Q mapped to the allocation unit ADI may include a read request queue and a write request queue. Also, depending on the read throughput and the write throughput of the allocation unit ADI, by varying the number of read request queues and the number of write request queues included in the input/output queue Q, or providing a request processing opportunity to the read request queue and the write request queue by a weighted round robin WRR method, read throughput, and write throughput of each allocation unit ADI may be guaranteed.

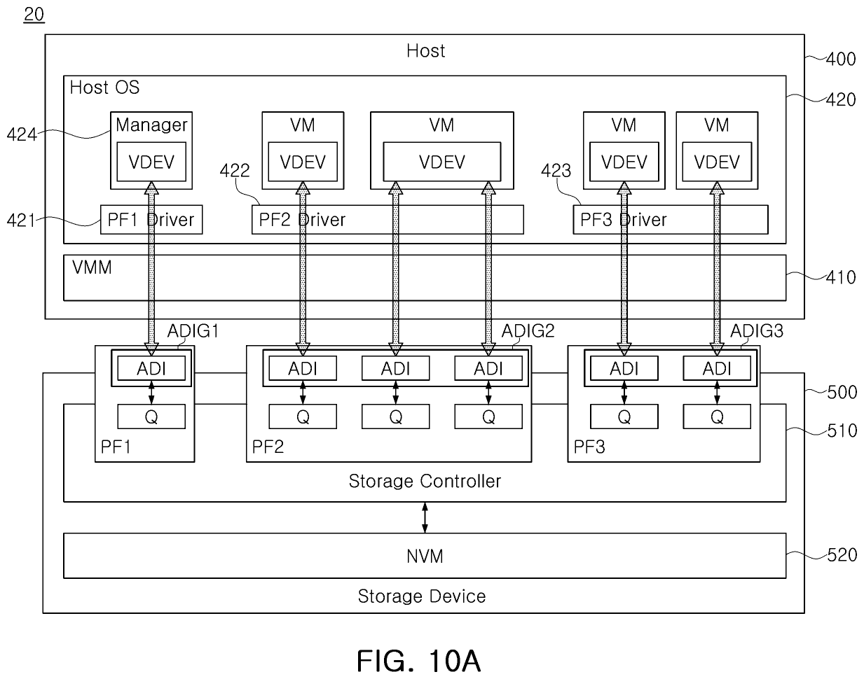

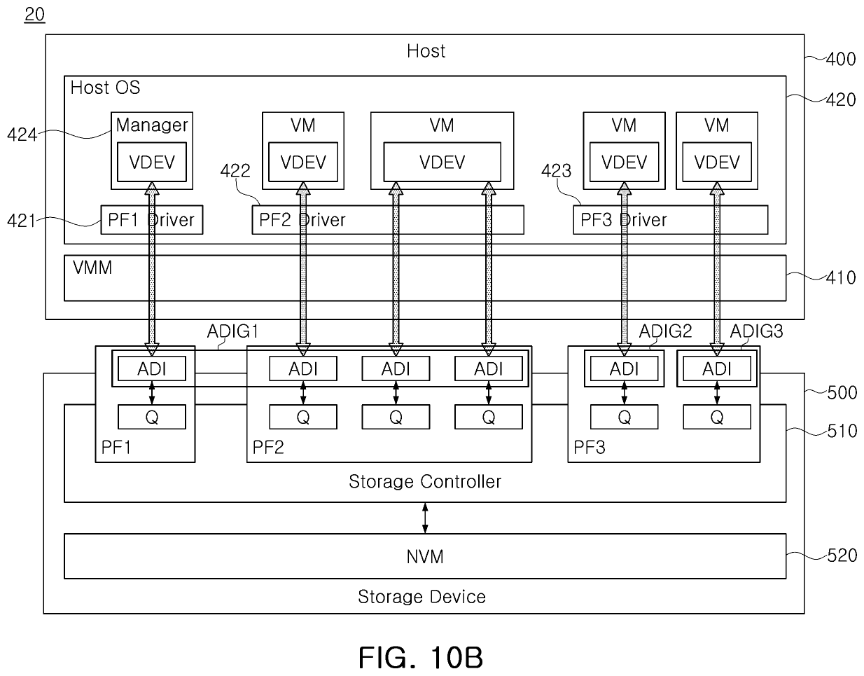

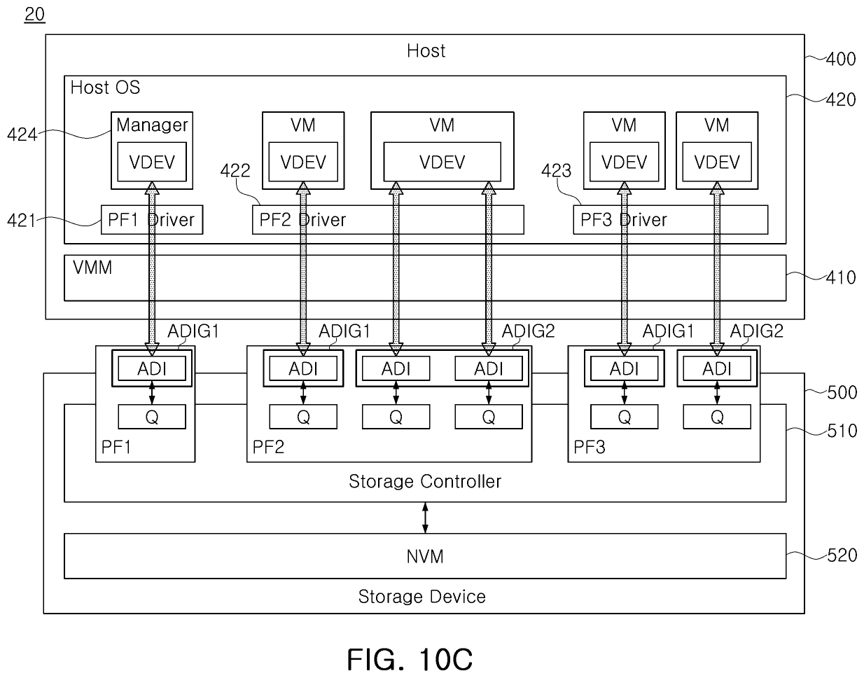

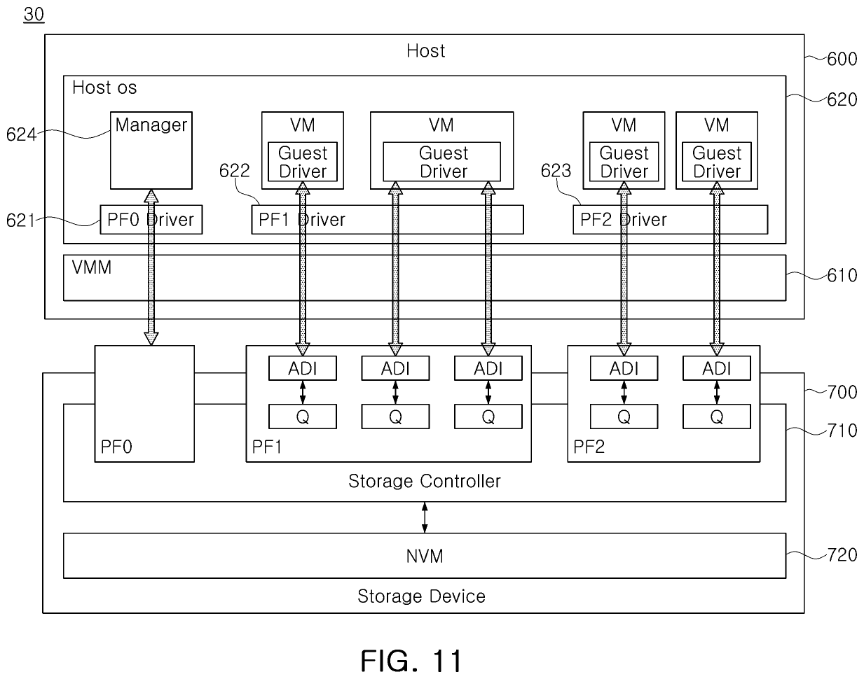

In FIGS. 1 to 9, an example in which the storage device 200 provides a single physical function PF is illustrated. However, an example embodiment thereof is not limited thereto. In the description below, a method of generating and managing a plurality of allocation units when the storage device 200 provides a plurality of physical functions will be described with reference to FIGS. 10A to 11.

FIGS. 10A to 10C are diagrams illustrating an electronic system according to an example embodiment.

Referring to FIG. 10A, an electronic system 20 may include a host 400 and a storage device 500. The host 400 and the storage device 500 may be similar to the host 100 and the storage device 200 described with reference to FIG. 1. However, the host 400 and the storage device 500 may support a plurality of physical functions PF1, PF2, and PF3.

The physical functions PF1, PF2, and PF3 may be distinguished from a virtual function, which is a lightweight PCIe function which shares one or more resources with the physical function. The physical functions PF1, PF2, and PF3 may appear as actual PCIe devices accessible from the host 400 even when host 100 does not support a single root input/output virtualization (SR-IOV) architecture. In other words, the storage device 500 may implement virtualization without relying on software conversion performed by the virtual machine manager 410 by providing the physical functions PF1, PF2, and PF3.

The plurality of physical functions PF1, PF2, and PF3 may be equivalent to each other, and each of the plurality of physical functions PF1, PF2, and PF3 may process input/output requests and also an admin-request such as a resource configuration request.

A manager 424 of the host 400 may identify the plurality of physical functions PF1, PF2, and PF3 provided by the storage device 500 and may obtain resource amount information of the storage device 500. Also, the manager 424 may determine storage capacity and QoS to be allocated to each of the plurality of physical functions PF1, PF2, and PF3, and may control the storage device 500 to allocate the determined storage capacity and QoS to each of the plurality of physical functions PF1, PF2, and PF3.

As described with reference to FIG. 1, each resource of the plurality of physical functions PF1, PF2, and PF3 may be subdivided by a plurality of allocation units ADI. Each of the plurality of allocation units ADI may be mapped to at least one input/output queue Q.

According to an example embodiment, the manager 424 may provide a resource configuration request defining a resource allocation rule for the allocation unit group to the plurality of physical functions PF1, PF2, and PF3 through the physical function drivers 421, 422, and 423 on the basis of the storage capacity and QoS allocated to the plurality of physical functions PF1, PF2, and PF3. In the example in FIG. 10A, a plurality of allocation units ADI included in a physical function may configure an allocation unit group. For example, the allocation unit ADI included in the first physical function PF1 may configure the first allocation unit group ADIG1, the allocation units ADI included in the second physical function PF2 may configure the second allocation unit group ADIG2, and the allocation units ADI included in the third physical function PF3 may configure the third each allocation unit group ADIG3.

The manager 424 may select a physical function in which an allocation unit ADI may be generated on the basis of the amount of resources required for the virtual machines VM and the resource allocation rule configured for each of the plurality of physical functions PF1, PF2, and PF3, and may determine the number of allocation units ADI to be allocated in the physical function. The manager 424 may provide an allocation unit generation request to a physical function driver corresponding to the physical function having the allocation unit group.

In example embodiments, the manager 424 may be executed in the secure core. The secure core may be a type of virtual machine which may provide enhanced security by executing in a different region from other virtual machines VM. The manager 424 executing on the secure core may control the amount of resources to be allocated to the plurality of physical functions PF1, PF2, PF3 and the plurality of allocation units ADI, thereby preventing a malicious user from hijacking the resources of the storage device 500.

FIG. 10A illustrates an example in which one or more allocation units ADI included in a physical function may configure an allocation unit group, but embodiments are not limited thereto. For example, a physical function may have two or more allocation unit groups, two or more physical functions may have an allocation unit group, or physical functions and allocation unit groups may have a many-to-many mapping relationship.

Referring to FIGS. 10B and 10C, an electronic system 20 may include the host 400 and the storage device 500 as described with reference to FIG. 10A, and the host 400 and the storage device 500 may support the plurality of physical functions PF1, PF2, and PF3. Each of the plurality of physical functions PF1, PF2, and PF3 may include one or more allocation units ADI.

In the example in FIG. 10B, the allocation units ADI included in the first physical function PF1 and the second physical function PF2 may configure an allocation unit group ADIG1. Also, the allocation units ADI included in the third physical function PF3 may configure two allocation unit groups ADIG2 and ADIG3.

For example, the manager 424 may provide a resource configuration request defining a resource allocation rule for the first allocation unit group ADIG1 to the first and second physical functions PF1 and PF2 through the physical function drivers 421 and 422. Also, the manager 424 may provide resource configuration requests defining resource allocation rules for the second and third each allocation unit group ADIG2 and ADIG3 to the third physical function PF3 through the physical function driver 423.

The manager 424 may select an allocation unit group in which the allocation unit ADI may be included on the basis of the amount of resources required for the virtual machines VMs and the resource allocation rule configured for each of the plurality of allocation unit groups ADIG1, ADIG2, and ADIG3, and may determine the number of allocation units ADI to be generated in the allocation unit group. The manager 424 may provide an allocation unit generation request to a physical function driver corresponding to the physical function having the allocation unit group.

In the example in FIG. 10C, the physical functions and the allocation unit groups may have a many-to-many mapping relationship. For example, the allocation units ADI included in the first to third physical functions PF1, PF2, and PF3 may configure the first allocation unit ADIG1, and the allocation units ADI included in the second and third physical functions PF2 and PF3 may configure the second allocation unit ADIG2.

The manager 424 may provide a resource configuration request defining a resource allocation rule for the first allocation unit group ADIG1 to the first to third physical functions PF1, PF2, and PF3 through the physical function drivers 421, 422, and 423, and may provide a resource configuration request defining the resource allocation rule for the second allocation unit group ADIG2 to the second and third physical functions PF2 and PF3 through the physical function drivers 422 and 423.

Embodiments of the storage device 500 are not limited to supporting the physical functions PF1, PF2, and PF3 equivalent to each other as described with reference to FIGS. 10A to 10C, and the plurality of physical functions may have a parent-child relationship.

FIG. 11 is a diagram illustrating an electronic system according to an example embodiment.

Referring to FIG. 11, an electronic system 30 may include a host 600 and a storage device 700. Similarly to the storage device described with reference to FIG. 10, the host 600 and the storage device 700 may support the plurality of physical functions PF0, PF1, and PF2.

The plurality of physical functions PF0, PF1, and PF2 may have a parent-child relationship. For example, the first physical function PF0 may be configured as a parent physical function, and the second and third physical functions PF1 and PF2 may be configured as child physical functions. The child physical functions may process input/output requests, and parent physical functions may process admin-requests to manage the child physical functions.

The manager 624 of the host 600 may be executed on the host operating system 620, similarly to the example described with reference to FIG. 1. The manager 624 may provide a resource configuration request or an allocation unit generation request to the first physical function PF0, which is the parent physical function. The first physical function PF0 may control the second and third physical functions PF1 and PF2, which are child physical functions, in response to the resource configuration request or the allocation unit generation request.

According to an example embodiment, the second and third physical functions PF1 and PF2 may include one or more allocation units ADI. In example embodiments, a child physical function may have one or more allocation unit groups. Also, the allocation units ADI included in two or more child physical functions may configure an allocation unit group, and the child physical functions and the allocation unit groups may have a many-to-many mapping relationship.

According to the example embodiments described with reference to FIGS. 10 and 11, the plurality of allocation units ADI may be typed for each of the plurality of physical functions. Accordingly, the resource management of the plurality of allocation units ADI and convenience of resource allocation for the plurality of virtual machines VM may be improved.

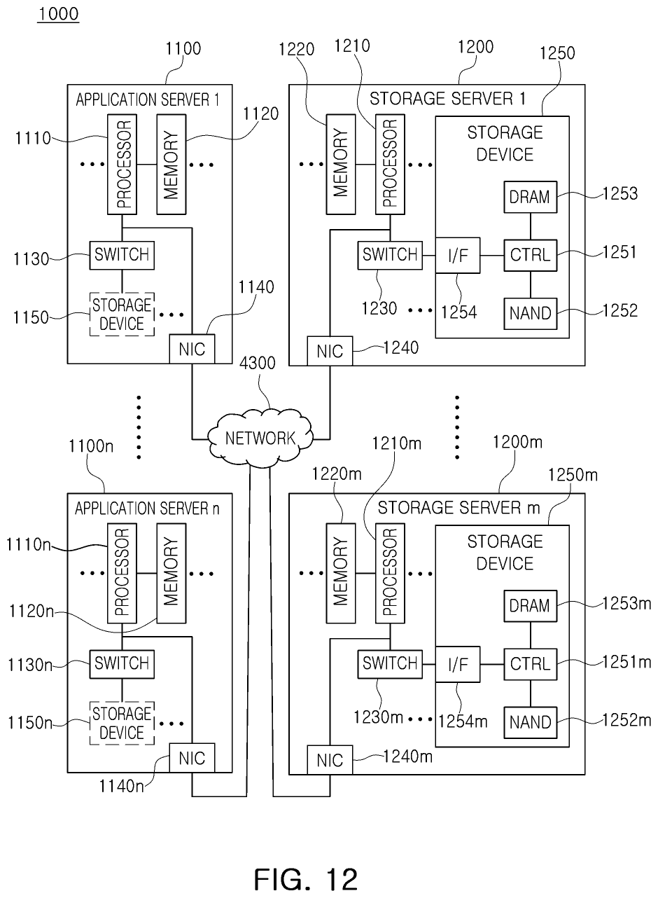

FIG. 12 is a diagram illustrating a server system to which an electronic system is applied according to an example embodiment.

Referring to FIG. 12, a data center 1000 may be implemented as a facility which collects various types of data and provides services, and may also be referred to as a data storage center. The data center 1000 may be configured as a system for operating a search engine and a database, or may be configured as a computing system used by companies such as a bank or a government agency. The data center 1000 may include application servers 1100 to 1100n and storage servers 1200 to 1200M. The number of the application servers 1100 to 1100n and the number of the storage servers 1200 to 1200M may be varied in example embodiments, and the number of the application servers 1100 to 1100n and the number of the storage servers 1200 to 1200M may be different.

The application server 1100 or the storage server 1200 may include at least one of processors 1110 or 1210 or memory 1120 or 1220. For example, the processor 1210 may control overall operations of the storage server 1200 and may access the memory 1220 and may execute instructions and/or data loaded into the memory 1220. The memory 1220 may be implemented as a double data rate synchronous DRAM (DDR SDRAM), high bandwidth memory (HBM), hybrid memory cube (HMC), dual in-line memory module (DIMM), Optane DIMM, and/or non-volatile DIMM (NVMDIMM). In example embodiments, the number of the processors 1210 and the number of the memory 1220 included in the storage server 1200 may be varied. In an example embodiment, the processor 1210 and the memory 1220 may provide a processor-memory pair. In an example embodiment, the number of processors 1210 and the amount of memory 1220 may be different. The processor 1210 may include a single core processor or a multi-core processor. The above description of the storage server 1200 may be similarly applied to the application server 1100. In example embodiments, the application server 1100 may not include the storage device 1150. The storage server 1200 may include at least one storage device 1250. The number of storage devices 1250 included in the storage server 1200 may be varied in example embodiments.

The application servers 1100 to 1100n and the storage servers 1200 to 1200m may communicate with each other through the network 1300. The network 1300 may be implemented using fiber channel (FC) or Ethernet. In this case, the FC may be a medium used for relatively high-speed data transmission, and an optical switch providing high performance/high availability may be used. Depending on an access method of the network 1300, the storage servers 1200 to 1200m may be provided as a file storage, a block storage, or an object storage.

In an example embodiment, the network 1300 may be configured as a storage-only network, such as a storage area network (SAN). For example, the SAN may be configured as an FC-SAN using an FC network and may be implemented according to the FC protocol (FCP). As another example, the SAN may be configured as an IP-SAN using a TCP/IP network and may be implemented according to the iSCSI (SCSI over TCP/IP or Internet SCSI) protocol. In another example embodiment, the network 1300 may be configured as a general network, such as a TCP/IP network. For example, the network 1300 may be implemented according to protocols such as FC over Ethernet (FCOE), network attached storage (NAS), and NVMe over fabrics (NVMe-oF).

Hereinafter, the application server 1100 and the storage server 1200 will be described. The description of the application server 1100 may also be applied to other application servers 1100n, and the description of the storage server 1200 may also be applied to other storage servers 1200m.

The application server 1100 may store data requested by a user or a client to one of the storage servers 1200 to 1200m through the network 1300. Also, the application server 1100 may obtain data read-out requested by a user or a client from one of the storage servers 1200 to 1200m through the network 1300. For example, the application server 1100 may be implemented as a web server or a database management system (DBMS).

The application server 1100 may access the memory 1120n or the storage device 1150n included in another application server 1100n through the network 1300, or may access the memories 1220-1220m or the storage device 1250-1250m included in the storage servers 1200-1200m through the network 1300. Accordingly, the application server 1100 may perform various operations on data stored in the application servers 1100-1100n and/or the storage servers 1200-1200m. For example, the application server 1100 may execute a command to move or copy data between the application servers 1100-1100n and/or the storage servers 1200-1200m. In this case, data may move from the storage device 1250-1250M of the storage servers 1200-1200m through the memories 1220-1220m of the storage servers 1200-1200m, or may move directly to the memory 1120-1120n of the application servers 1100-1100n. Data moving through the network 1300 may be encrypted for security or privacy.

For example, in the storage server 1200, the interface 1254 may provide a physical connection between the processor 1210 and the controller 1251 and a physical connection between the NIC (Network InterConnect) 1240 and the controller 1251. For example, the interface 1254 may be implemented as a direct attached storage (DAS) method of directly connecting the storage device 1250 using a dedicated cable. Also, for example, the interface 1254 may be implemented as various interface methods such as advanced technology attachment (ATA), serial ATA (SATA), external SATA (e-SATA), small computer small interface (SCSI), serial attached SCSI (SAS), PCI peripheral component interconnection (SAS), PCIe PCI express), NVM express (NVMe), IEEE 1394, universal serial bus (USB), secure digital (SD) card, multi-media card (MMC), embedded multi-media card (eMMC), universal flash storage (UFS), embedded universal flash storage (eUFS), and/or compact flash (CF) card interface.

The storage server 1200 may further include a switch 1230 and an NIC 1240. The switch 1230 may selectively connect the processor 1210 to the storage device 1250, or may selectively connect the NIC 1240 to the storage device 1250 under control of the processor 1210.

In an example embodiment, the NIC 1240 may include a network interface card, a network adapter, or the like. The NIC 1240 may be connected to the network 1300 by a wired interface, a wireless interface, a Bluetooth interface, an optical interface, or the like. The NIC 1240 may include an internal memory, a digital signal processor (DSP), a host bus interface, or the like, and may be connected to the processor 1210, and/or the switch 1230 through a host bus interface. The host bus interface may be implemented as one of the examples of interface 1254 described above. In an example embodiment, the NIC 1240 may be integrated with at least one of the processor 1210, the switch 1230, or the storage device 1250.

In the storage servers 1200-1200m or the application servers 1100-1100n, the processor may program or read data by sending a command to the storage device 1150-1150n and 1250-1250m or the memory 1120-1120n and 1220-1220m. In this case, the data may be error-corrected data through an error correction code (ECC) engine. The data may be data having been processed through data bus inversion (DBI) or data masking (DM), and may include cyclic redundancy code (CRC) information. The data may be encrypted for security or privacy.

The storage devices 1150-1150n and 1250-1250m may transmit control signals and command/address signals to the NAND flash memory device 1252-1252m in response to a read command received from the processor. Accordingly, when reading out data from the NAND flash memory device 1252-1252m, a read enable (RE) signal may be input as a data output control signal and may serve to output data to the DQ bus. data strobes (DQS) may be generated using the RE signal. Command and address signals may be latched in the page buffer depending on a rising or a falling edge of the write enable (WE) signal.

The controller 1251 may generally control operations of the storage device 1250. In an example embodiment, the controller 1251 may include static random access memory (SRAM). The controller 1251 may write data to the NAND flash 1252 in response to a write command, or read-out data from the NAND flash 1252 in response to a read-out command. For example, a write command and/or a read-out command may be provided from the processor 1210 in the storage server 1200, the processor 1210m in another storage server 1200m, or the processors 1110 and 1110n in the application servers 1100 and 1100n. The DRAM 1253 may temporarily store (buffer) data to be written to the NAND flash 1252 or data read out from the NAND flash 1252. Also, the DRAM 1253 may store metadata. Here, metadata may be generated by the controller 1251 to manage user data or the NAND flash 1252. The storage device 1250 may include a secure element (SE) for security or privacy.

The electronic system 10, 20, and 30 in the example embodiments described with reference to FIGS. 1 to 11 may be applied to the application server 1100 or the storage server 1200 in FIG. 12. For example, in the storage server 1200, the processor 1210 may execute a plurality of virtual machines on the host operating system. Also, the storage device 1250 may provide a plurality of virtual storage devices for the plurality of virtual machines.

According to an example embodiment, the storage device 1250 may provide one or more physical functions, and resources possessed by the physical functions may be subdivided into a plurality of allocation units. The processor 1210 may type the plurality of allocation units by defining resource allocation information for the plurality of allocation unit groups and providing a resource configuration request notifying the resource allocation information to the storage device 1250. The processor 1210 may control the storage device 1250 to generate one or more allocation units included in one or more allocation unit groups on the basis of the amount of resources required for the virtual machine, and may provide storage resources to a virtual machine by mapping the one or more allocation units to a virtual storage device corresponding to the virtual machine.

According to an example embodiment, convenience of resource management of the plurality of allocation units and resource allocation for the plurality of virtual machines may be improved, such that overhead may be reduced. Also, requests corresponding to the plurality of allocation units may be scheduled on the basis of a credit-based multiple round robin method, and stable performance may be provided to virtual storage devices.

According to the aforementioned example embodiments, by defining resource allocation information for the allocation unit groups and mapping the individual allocation units to the allocation unit groups, resources may be allocated to the individual allocation units on the basis of the defined resource allocation information, and by configuring the virtual storage device with one or more of the individual allocation units, overhead for configuring the virtual storage device may be reduced.

Also, by scheduling requests corresponding to the individual allocation units on the basis of the allocation unit groups and the amount of resource allocation of individual allocation units included in on the basis of allocation unit groups, stable performance may be provided to the virtual storage devices configured with one or more of the individual allocation units.

While the example embodiments have been illustrated and described above, it will be configured as apparent to those skilled in the art that modifications and variations could be made without departing from the scope of the present disclosure as defined by the appended claims.

What is claimed is:

1. A method of operating an electronic system, the method comprising:
identifying a physical function provided by an input/output device and obtaining resource amount information of the input/output device;
determining a resource allocation rule for each of a plurality of allocation unit groups of the input/output device based on the resource amount information;
selecting one or more allocation unit groups among the plurality of allocation unit groups based on a required amount of resources and input/output properties of a virtual machine and the resource allocation rule determined for each of the plurality of allocation unit groups;
generating one or more allocation units for the selected one or more allocation unit groups; and
mapping the one or more allocation units to the virtual machine.

2. The method of claim 1,
wherein the input/output device includes a storage device, and
wherein the determining a resource allocation rule includes determining a storage capacity and a quality of service (QOS) of allocation units to be generated from the plurality of allocation unit groups, respectively, in response to one or more resource configuration requests.

3. The method of claim 2, wherein the QoS includes write throughput, write latency, read throughput, and read latency.

4. The method of claim 1,
wherein the input/output device includes a storage device, and
wherein the determining a resource allocation rule includes determining a total storage capacity and a total throughput of each of the plurality of allocation unit groups in response to one or more resource configuration requests.

5. The method of claim 4, wherein the generating the one or more allocation units for the selected one or more allocation unit groups includes generating an allocation unit having a determined storage capacity and a determined throughput in a range of total storage capacity and total throughput of the selected one or more allocation unit groups in response to an allocation unit generation request specifying an identifier of the allocation unit and the selected one or more allocation unit groups.

6. The method of claim 4, wherein the generating one or more allocation units for the selected one or more allocation unit groups includes generating, in response to an allocation unit generation request specifying an identifier of the allocation unit, a storage capacity of the allocation unit, and the selected one or more allocation unit groups, an allocation unit having the specified storage capacity and a throughput determined in proportion to the specified storage capacity in a range of total storage capacity and total throughput of the selected one or more allocation unit groups.

7. The method of claim 4, wherein the determining a resource allocation rule includes determining a ratio between read throughput and write throughput of each of the plurality of allocation unit groups in response to the one or more resource configuration requests.

8. The method of claim 4,
wherein each of the input/output properties are one of read-intensive properties, write-intensive properties, and mixed properties, and
wherein the selecting one or more allocation unit groups among the plurality of allocation unit groups includes selecting the one or more allocation unit groups based on a ratio between read throughput and write throughput of each of the plurality of allocation unit groups and the input/output properties.

9. The method of claim 1,
wherein the physical function corresponds to an input/output port, and
wherein the one or more allocation units are configured as an allocatable device interface (ADI) supported by a scalable input/output virtualization (S-IOV) architecture.

10. The method of claim 1, wherein a request for each of the plurality of allocation units generated in the physical function is identified by a process address space identifier (PASID).

11. A method of operating an electronic system, the method comprising:
generating a plurality of allocation unit groups with each having different resource allocation rules in response to a resource configuration request;
receiving allocation unit generation requests, each allocation unit generation request respectively specifying one of the plurality of allocation unit groups;
generating a plurality of allocation units included in the plurality of allocation unit groups in response to the allocation unit generation requests;
mapping the plurality of allocation units included in the plurality of allocation unit groups to a plurality of input/output queues provided by a storage controller; and
allocating throughput to each of the plurality of allocation units based on the resource allocation rules.

12. The method of claim 11, further comprising:
receiving input/output requests and queuing each of the input/output requests to one of the plurality of input/output queues based on an identifier of each of the input/output requests; and
providing a request processing opportunity to one of the plurality of input/output queues by a multiple round robin method based on an allocation unit group and an allocation unit corresponding to each of the plurality of input/output queues; and
processing requests queued in an input/output queue having the request processing opportunity.

13. The method of claim 12,
wherein the providing a request processing opportunity by a multiple round robin method to one of the plurality of input/output queues includes:
providing the request processing opportunity to the plurality of allocation unit groups by a first round robin method,
providing the request processing opportunity provided to one allocation unit group to one of the plurality of allocation unit groups to a plurality of allocation units included in the one allocation unit group by a second round robin method, and
providing the request processing opportunity provided to one allocation unit among the plurality of allocation units to an input/output queue mapped to the one allocation unit.

14. The method of claim 13, wherein each of the first round robin method and the second round robin method is one of a simple round robin method and a weighted round robin method.

15. The method of claim 13, further comprising:
determining a weight for the first round robin method of each of the plurality of allocation unit groups according to a ratio of a throughput of each of the plurality of allocation unit groups.

16. The method of claim 12, wherein each of the plurality of input/output queues includes a read request queue and a write request queue.

17. The method of claim 11, further comprising:
determining a size of a periodically repeated time window;
determining a throughput for each of the plurality of allocation unit groups based on a throughput allocated to the plurality of allocation units;
allocating a plurality of credits for each of the plurality of allocation unit groups for each time window based on a size of the time window and the throughput for each of the plurality of allocation unit groups; and
processing requests queued in an input/output queue and deducting a determined number of credits depending on a size of input/output data corresponding to the processed request from allocated credits for an allocation unit group associated with the input/output queue.

18. The method of claim 17, wherein the method further includes skipping request processing for the input/output queue when a credit of an allocation unit group associated with the input/output queue is exhausted when an input/output queue has a request processing opportunity.

19. The method of claim 11, further comprising:
allocating a namespace having a storage capacity determined based on the resource allocation rules to each of the plurality of allocation units.

20. A method of operating an electronic system, the method comprising:
identifying a plurality of physical functions provided by an input/output device and obtaining resource amount information of the input/output device;
allocating a storage capacity and a quality of service (QOS) to each of the plurality of physical functions based in part on the resource information;
providing a resource configuration request to determine a resource allocation rule to each of the plurality of physical functions based on the storage capacity and the QoS allocated to each of the plurality of physical functions;
selecting a physical function for which an allocation unit is generated based on an amount of a resource requested by a virtual machine and the resource allocation rule configured for each of the plurality of physical functions;
generating one or more allocation units for the selected physical function by providing an allocation unit generation request to the selected physical function; and
mapping the one or more allocation units to the virtual machine.
